(19) United States
(12) Patent Application Publication
(10) Pub. No.: US 2015/0198556 A1
(43) Pub. Date: Jul. 16, 2015

(54) SENSING ELECTRODE OF ENZYME-BASED SENSOR AND METHOD FOR MANUFACTURING THE SAME

(71) Applicant: National Central University, Taoyuan County (TW)

(72) Inventors: Jeng-Kuei CHANG, Hsinchu City (TW); Jia-Wun WU, Kaohsiung (TW); Sheng-Wei LEE, Taipei City (TW); Chueh-Han WANG, Taipei City (TW); Yi-Chen WANG, New Taipei City (TW)

(21) Appl. No.: 14/333,367

(22) Filed: Jul. 16, 2014

(30) Foreign Application Priority Data
Jan. 10, 2014 (TW) 103100956

(51) Int. Cl. G01N 27/327

(52) U.S. Cl. CPC G01N 27/3271

(57) ABSTRACT

The present invention relates to a sensing electrode of an enzyme-based sensor, and the enzyme-based sensor comprising the same can be stably stored at room temperature. The sensing electrode comprises: an electrode substrate and an enzyme sensing layer formed thereon, wherein the enzyme sensing layer comprises sequentially laminated layers of: a first carbon material-nano metal layer containing a carbon material and nano-metal particles; an ionic liquid layer comprising an ionic liquid consisting of a cation and an anion; a second carbon material-nano metal layer containing a carbon material and nano-metal particles; and an enzyme layer. The present invention also provides a method for manufacturing the sensing electrode of an enzyme-based sensor.

### CROSS REFERENCE TO RELATED APPLICATION

This application claims the benefits of the Taiwan Patent Application Serial Number 103100956, filed on Jan. 10, 2014, the subject matter of which is incorporated herein by reference.

### BACKGROUND OF THE INVENTION

1. Field of the Invention

The present invention relates to a sensing electrode of an enzyme-based sensor, and particularly to an enzyme-based electrochemical sensor made from the sensing electrode sensor, which has a high sensitivity and can be stably stored at room temperature and a method for manufacturing the sensing electrode of an enzyme-based sensor.

2. Description of Related Art

With the improvement of living standards and increase of the average life expectancy, modern people start thoughtfully considering and pursuing high quality of medical care and high quality of life. The monitoring of health condition or environmental pollution is the embodiment of this pursuit of high quality of life.

More specifically, monitoring of health status can be realized, for example, by taking advantage of biochemical sensors to provide instant message, thereby facilitating health self-management. For example, patients with diabetes require regular blood glucose monitoring several times a day, to be alerted to the large fluctuation in blood glucose levels caused by food intake. Therefore, the glucose sensor commodities which are fast, sensitive, simple to operation, and easy to carry have become the mainstream of current market, among which electrochemical sensors are relatively more mature than others.

Electrochemical sensors operate by a reaction between an active material and the analyte on the electrode surface, which generates a potential or current output to be interpreted by the user. Because it relies on the electrode as the primary detection tool, selection of the electrode material is very important.

In general, there are four main indicators to estimate an electrochemical sensor. The first is stability. The sensor that has been used for a period of time has a reduced stability due to the impact of environmental factors, such as temperature, humidity, or chemicals, etc., and therefore, the lesser degree of affection by environmental factors, the better the stability. The second is selectivity. A biological specimen usually contains several chemicals. For example, blood contains dopamine, uric acid, ascorbic acid and so on at the same time. When fructose valine is selected for detection, if other substances, such as dopamine, uric acid, ascorbic acid and so on have a relatively much smaller response current, it represents a good selectivity of the fructose valine. The third is sensitivity, which refers to an identification degree of the sensing system on analytes, and the formula is: sensitivity S=ΔI/(ΔC×A), wherein ΔI represents the response current (μA or mA), ΔC represents the analyte concentration (μM or mM), and A represents the electrode surface area (cm²). The last is response time, which refers to the time required for realization of 90% stable response current after the analytes are introduced into the electrochemical sensing system.

In recent years, studies have even tried to combine the electrochemical sensor with enzyme. Therefore, electrochemical sensors can be roughly classified into enzyme-based electrochemical sensors and enzymeless electrochemical sensors based on their combination with enzyme or not.

The enzymeless electrochemical sensor has a lower detection limit. The enzymeless electrochemical sensor also can withstand a larger change in pH, and can be stored under less stringent conditions. However, in terms of sensitivity, there is still much room for improvement, and the disruption of chemicals (such as ascorbic acid, dopamine, uric acid and so on) is merely alleviated but not completely eliminated. In comparison, enzyme-based electrochemical sensors inheriting the high specificity and high sensitivity of enzyme, are able to effectively monitor the glucose concentration in the blood, and have a significantly advance on the specificity to the test specimen, thus preventing disruptors from affecting the measurement results. However, enzymes have a more stringent environmental restriction for storage. In general, enzymes need to be stored under a low temperature (for example, 4° C.), while the room temperature will cause enzymes to lose its original activity, thus limiting development of the enzyme-based electrochemical sensors.

However, since the enzyme-based sensors possess the specificity that the enzymeless sensors don't have, there are still a lot of researches focusing on improvement of the shortcomings of the enzyme-based sensors. The proposed invention is hereby to solve the shortcomings of the enzyme-based sensors.

### SUMMARY OF THE INVENTION

An object of the present invention is to provide a sensing electrode of an enzyme-based sensor, in order to prepare an enzyme-based sensor having a high sensitivity and can be stably stored at room temperature, and also provide a method for manufacturing the sensing electrode of an enzyme-based sensor.

Specifically, the present invention enhances the sensitivity of the sensing electrode of the enzyme-based sensor and greatly improves the stability of the sensing electrode through a combination of carbon material and nano-metal particles and the addition of the ionic liquid layer to provide a good interaction between the ionic liquid with a high ionic conductivity and the carbon material. Meanwhile, the combination with enzyme also increases the enzyme activity and stability.

To achieve the above object, the present invention provides a sensing electrode of an enzyme-based sensor, comprising: an electrode substrate and an enzyme sensing layer formed thereon, wherein the enzyme sensing layer comprises sequentially laminated layers of: a first carbon material-nano metal layer containing a carbon material and nano-metal particles; an ionic liquid layer comprising an ionic liquid consisting of a cation and an anion; a second carbon material-nano metal layer containing a carbon material and nano-metal particles; and an enzyme layer. In other words, the ionic liquid layer is sandwiched between the first carbon material-nano metal layer and the second carbon material-nano metal layer.

The carbon material used herein is not particularly limited, and specifically may be selected from the group consisting of: graphene, carbon black, a multi-wall carbon nanotube, a single-wall carbon nanotube, activated carbon, and a carbon sphere. In the above-mentioned carbon materials, graphene or a carbon nanotube is preferably used as the carbon material. In the production of carbon nanotubes, the metal catalyst easily remain in the carbon tube, and even after being subjected to the subsequent treatment, the metal particles still quite easily remain therein. However, researches and development of carbon nanotubes are relatively mature comparing to graphene, and therefore carbon nanotubes currently have a very wide range of applications in various fields; as for graphene, although it is a novel material having a number of features needing to be clarified, graphene has a large specific surface area, which may serve as the active site, as well as bipolar characteristics, which may serve as the chemical gate of materials. The above two characteristics mean that the decomposition of molecules on graphene can be easily detected. The present invention preferably employs graphene as the carbon material.

In the present invention, the nano metal particle used herein is not particularly limited, as long as it is a nanoparticle having a good catalytic ability, such as gold nanoparticles, silver nanoparticles, platinum nanoparticles and palladium nanoparticles. Specifically, in an embodiment of the present invention, gold nanoparticles are used. The gold nano-composite can increase the enzyme stability, maintain its activity and provide great catalytic properties.

The ion liquid is defined as a salt whose components are all ions and present in a liquid state below 100° C., and the polarity, hydrophilicity, viscosity of the ionic liquid and the solvent solubility may be modified to possess the desired physical and chemical properties via combinations of various cations and anions. Generally, the longer the carbon chain of cations, the more hydrophobic the ionic liquid. Ionic liquids can be divided into two categories: the hydrophobic and hydrophilic ionic liquids. They are mainly distinguished by the anionic species, and for example, PF₆⁻, TFSI⁻ and the like belong to the hydrophobic ionic liquid; while DCA⁻, I⁻, Cl⁻ and the like belong the hydrophilic ionic liquid. However, in some cases such as BF₄⁻, CF₃SO₃⁻ and the like, the hydrophobicity and hydrophilicity can vary with the length of the carbon chain of cations. In general, a cation with a carbon chain length of 6 or more is hydrophobic, whereas a cation with a shorter carbon chain length is hydrophilicity. In the present invention, the ionic liquid for forming the ionic liquid layer is composed of an anion and a cation, wherein the cation of the ionic liquid may be, for example: N-alkyl-N-alkyl-pyrrolidinium, 1-alkyl-3-alkyl imidazolium, N-alkyl-N-alkyl-piperidinium, tetraalkylammonium, tetraalkylphosphonium, 1,2-dialkylpyrazolium, N-alkylthiazolium, or trialkylsufonium. The anions of the ionic liquid may be, for example: bis(trifluoromethyl)sulfonyl imide (TFSI), dicyanamide (DCA), trifluoromethanesulfonate, tetrafluoroborate, or hexafluorophosphate. Specifically, the ionic liquid formed of any combination of the above anions and cations may be used in the present invention, for example: N-butyl-N-methyl pyrrolidinium bis(trifluoromethyl)sulfonyl imide (BMPTFSI), 1-ethyl-3-methylimidazolium bis(trifluoromethyl)sulfonyl imide (EMITFSI) or so on.

As the enzyme layer, a glucose oxidase or a fructose valine oxidase may be used. The glucose oxidase is used to standardize the glucose concentration of glucose by detecting the current of hydrogen peroxide, wherein hydrogen peroxide and glucose lactone are generated from the reaction between glucose and the glucose oxidase. However, the blood glucose level is often affected by food intake, and therefore, glycosylated hemoglobin (HbAlc) corresponding to the average blood glucose value within 2-3 months, which does not significantly vary due to glucose uptake in a single day, has become the ideal biological indicator to provide a more accurate diagnosis. Glycosylated hemoglobin is the product of the reaction between glucose and a hemoglobin, and more specifically, is a more stable fructose valine formed by a condensation reaction between a ketone group of glucose and an amino group in the N-terminal valine of the hemoglobin. Therefore, when the fructose valine and fructose valine oxidase are reacted to generate valine, glucose ketoaldehyde and hydrogen peroxide, fructose valine concentration can be standardized by detecting the current of hydrogen peroxide, thereby detecting the indicator for the long-term glycosylated hemoglobin level.

The present invention also provides a method for manufacturing the sensing electrode of an enzyme-based sensor, comprising: (A) coating a slurry comprising a carbon material and nano-metal particles on an electrode substrate to form a first carbon material-nano metal layer; (B) coating an ionic liquid consisting of a cation and an anion on the first carbon material-nano metal layer to form an ionic liquid layer; (C) coating the slurry of the step (A) on the ionic liquid layer to form a second carbon material-nano metal layer, so that the ionic liquid layer is sandwiched between the first carbon material-nano metal layer and the second carbon material-nano metal layer; and (D) forming an enzyme layer on the second carbon material-nano metal layer.

The supercritical fluid has properties of both a liquid and a gas, featured by a high diffusivity, a low viscosity, and an interfacial tension of near zero. The carbon material and the nano-metal particles in the step (A) are preferably formed into a carbon material-nano metal composite in a supercritical carbon dioxide environment, so as to uniformly disperse the nano-metal particles on the carbon material to drastically increase the surface area for reaction.

As for the carbon material, the nano-metal particles, the ionic liquid, and enzymes, used in the method for manufacturing the sensing electrode of an enzyme-based sensor, have been described in detail previously, and is not repeated here.

Further, after the step (C), the steps (B) and (C) may be sequentially repeated to form a multilayer structure.

Other objects, advantages, and novel features of the invention will become more apparent from the following detailed description when taken in conjunction with the accompanying drawings.

### BRIEF DESCRIPTION OF THE DRAWINGS

FIGS. 1A to 1E show the results of detecting various glucose concentrations measured by cyclic voltammetry (CV) using the sensing electrode of the enzyme-based glucose sensor fixed by various ionic liquids.

FIGS. 1F to 1J show the results of detecting various fructose valine concentrations measured by cyclic voltammetry (CV) using the sensing electrode of the enzyme-based fructose valine sensor fixed by various ionic liquids.

FIG. 2A shows the linear calibration graph of the glucose concentration versus the responding current of the sensing electrode of the enzyme-based glucose sensor fixed by various ionic liquids.

FIG. 2B shows the linear calibration graph of the fructose valine concentration versus the responding current of the sensing electrode of the enzyme-based fructose valine sensor fixed by various ionic liquids.

FIGS. 3A and 4A show the test result of the serving life of the sensing electrode of the enzyme-based glucose sensor fixed by various ionic liquids.

FIGS. 3B and 4B show the test result of the serving life of the sensing electrode of the enzyme-based fructose valine sensor fixed by various ionic liquids.

FIGS. 5A and 5B shows the effect of disruptors on the sensing electrode of the enzyme-based fructose valine sensor cyclic according to a preferred example of the present invention by cyclic voltammetry.

### DETAILED DESCRIPTION OF THE PREFERRED EMBODIMENT

The making and using of the embodiments of the disclosure are discussed in detail below. It should be appreciated, however, that the embodiments provide many applicable inventive concepts that can be embodied in a wide variety of specific contexts. The specific embodiments discussed are merely illustrative, and do not limit the scope of the disclosure.

### EXAMPLE 1-1

Graphene prepared by the Staudenmaier method was used as the carbon material. A fixed amount of commercially available natural graphite (purity of 99.9%, 150 mesh or more) was added with sulfuric acid and nitric acid as the oxidizing agent, and potassium chlorate as the intercalating agent, and kept for 96 hours under temperature control. After then, it was washed with a large amount of deionized water and sulfuric acid repeatedly, followed by washing with deionized water and then drying. The obtained graphene oxide was grinded in an agate mortar and then transferred into a high temperature furnace which was fed with the gas mixture of an inert gas (argon) and a reaction gas (hydrogen) for reduction at a heat-up rate of 60° C. per minute. When the temperature reached about 300° C., the spacing of the graphite layer was opened up, and the temperature was continued to ramp-up to 1100° C. and kept for one hour, and graphene was obtained after furnace cooling.

Supercritical carbon dioxide was employed to prepare gold nanoparticles to serve as nano-metal particles. The operating temperature and pressure were 50° C. and 100 bar. 49 mL of methanol (>99.9%, methanol, TEDIA) was used as the solvent; 26 mg of gold (III) chloride trihydrate (16961-25-4, HAuCl₄.3H₂O, Aldrich) was used the gold precursor; 40 mg of graphene was used as the loading material; and the reductant was a 1.36M solution prepared from dimethylamine borane (>95.0%, DMAB, TCI) with addition of 1 mL of deionized water.

Graphene was added into the methanol solution, ultrasonicated for 10 minutes to uniformly disperse the graphene, and then placed in a supercritical reaction chamber, followed by addition of the gold precursor and the reducing agent and pressurization to 100 bar. The reaction was performed in supercritical carbon dioxide for one hour at 50° C., and finally, the graphene-gold composite was collected by repeated centrifugation with methanol and then oven dried.

Next, 1 mg of graphene-gold composite was added to 260 μm of isopropyl alcohol (>99.5, IPA, TEDIA) to serve as the solvent; and 40 μm of the ion exchange resin (5 wt % Nation, Aldrich) was used as the binding agent with an electrode substrate. The above mixture was uniformly mixed in an ultrasonic oscillator for more than one hour to obtain the desired slurry.

Then, a suitable amount of N-butyl-N-methyl pyrrolidinium bis(trifluoromethyl)sulfonyl imide (BMPTFSI) ionic liquid (IL) was diluted with isopropyl alcohol (IPA) (IL/IPA, v/v= 1/10) in a glove box (Glove box, Innovation Technology, O₂<0.1 ppm, moisture of <0.1 ppm).

8 μL of the obtained slurry was evenly coated on a 0.196 cm² disposable screen-printed electrode having a diameter of 5 mm, and 7 μL of the diluted ion liquid was added thereto. Then, 7 μL of the above slurry was applied for the second time, wherein the total volume of the twice applied slurry was maintained at 15 μL. After air drying, 4.5 mg of the glucose oxidase (type X-S, lyophilized powder, 100-250 units/mg solid) was prepared into the enzyme solution using 100 μL of the phosphate buffer solution (PBS). 8 μL of the above glucose oxidase solution was dropwise added onto the air-dried slurry, which resulted in about 50 units of the glucose oxidase on each sensing electrode. The electrode was then dried in a 4° C. refrigerator for 4 hours, thus completing the preparation of the sensing electrode.

### EXAMPLE 1-2

The sensing electrode was prepared by the same method as in Example 1-1, except that N-butyl-N-methyl pyrrolidinium bis(trifluoromethyl)sulfonyl imide (BMPTFSI) was replaced by 1-ethyl-3-methylimidazolium bis(trifluoromethyl)sulfonyl imide (EMITFSI) ionic liquid (IL).

### EXAMPLE 1-3

The sensing electrode was prepared by the same method as in Example 1-1, except that N-butyl-N-methyl pyrrolidinium bis(trifluoromethyl)sulfonyl imide (BMPTFSI) was replaced by N-butyl-N-methyl pyrrolidinium dicyanamide (BMPDCA) ionic liquid (IL).

### EXAMPLE 1-4

The sensing electrode was prepared by the same method as in Example 1-1, except that N-butyl-N-methyl pyrrolidinium bis(trifluoromethyl)sulfonyl imide (BMPTFSI) was replaced by 1-ethyl-3-methylimidazolium dicyanamide (EMIDCA) ionic liquid (IL).

### COMPARATIVE EXAMPLE 1-1

The sensing electrode was prepared by the same method as in Example 1-1, except that no ionic liquid was introduced.

### EXAMPLE 2-1

The slurry including the graphene-gold composite and N-butyl-N-methyl pyrrolidinium bis(trifluoromethyl)sulfonyl imide (BMPTFSI) ionic liquid (IL) diluted in isopropyl alcohol (IPA) were prepared by the same steps as in Example 1-1. Next, 2 μL of the obtained slurry was evenly coated on a 0.071 cm² disposable screen-printed electrode having a diameter of 3 mm, and 2 μL of the diluted ion liquid was added thereto. Then, 2 μL of the above slurry was applied for the second time, wherein the total volume of the twice applied slurry was maintained at 5 μL. After air drying, 10 units fructose valine oxidase (Fructosyl-Amino Acid Oxidase, recombinant, expressed in E. Coli, lyophilized powder, ≧0.45 units/mg protein) was prepared into the enzyme solution using 10 μL of the phosphate buffer solution (PBS). 3 μL of the above fructose valine oxidase solution was dropwise added onto the air-dried slurry, which resulted in about 0.2 units of the fructose valine oxidase on each sensing electrode. The electrode was then dried in a 4° C. refrigerator for 4 hours, thus completing the preparation of the sensing electrode.

### EXAMPLE 2-2

The sensing electrode was prepared by the same method as in Example 2-1, except that N-butyl-N-methyl pyrrolidinium bis(trifluoromethyl)sulfonyl imide (BMPTFSI) was replaced by 1-ethyl-3-methylimidazolium bis(trifluoromethyl)sulfonyl imide (EMITFSI) ionic liquid (IL).

### EXAMPLE 2-3

The sensing electrode was prepared by the same method as in Example 2-1, except that N-butyl-N-methyl pyrrolidinium bis(trifluoromethyl)sulfonyl imide (BMPTFSI) was replaced by N-butyl-N-methyl pyrrolidinium dicyanamide (BMPDCA) ionic liquid (IL).

### EXAMPLE 2-4

The sensing electrode was prepared by the same method as in Example 2-1, except that N-butyl-N-methyl pyrrolidinium bis(trifluoromethyl)sulfonyl imide (BMPTFSI) was replaced by 1-ethyl-3-methylimidazolium dicyanamide (EMIDCA) ionic liquid (IL).

### COMPARATIVE EXAMPLE 2-1

The sensing electrode was prepared by the same method as in Example 2-1, except that no ionic liquid was introduced. Hereinafter, the effects of the various ionic solutions on the characteristics of the enzyme-based glucose sensor and the enzyme-based fructose valine will be discussed.

TABLE 1

| | | Ionic liquid | enzyme |
|---|---|---|---|
| enzyme-based | Example 1-1 | BMPTFSI | Glucose oxidase |
| glucose | Example 1-2 | EMITFSI | Glucose oxidase |
| sensor | Example 1-3 | BMPDCA | Glucose oxidase |
| | Example 1-4 | EMIDCA | Glucose oxidase |
| | Comparative | Absent | Glucose oxidase |
| | Example 1-1 | | |
| enzyme-based | Example 2-1 | BMPTFSI | Fructose valine oxidase |
| fructose | Example 2-2 | EMITFSI | Fructose valine oxidase |
| valine sensor | Example 2-3 | BMPDCA | Fructose valine oxidase |
| | Example 2-4 | EMIDCA | Fructose valine oxidase |
| | Comparative | Absent | Fructose valine oxidase |
| | Example 2-1 | | |

A three-electrode cell with an AUTOLAB PGSTAT302N (Metrohm) potentiostat was used. The above sensing electrodes prepared in the Examples and Comparative Examples were used as a working electrode, a platinum wire was used as the counter electrode, Ag/AgCl (3M KCl) was used as reference electrode, and the electrolyte solution was 0.1M phosphate buffer solution which was prepared from Na₂HPO₄(>99.0%, SHOWA), NaH₂PO₄(>99.0, SHOWA) and KCl (>99.0%, SHOWA). When the sensing material was glucose (>98.0%, D(+)-glucose (Dextrose Anhydrous), SHOWA), the corresponding enzyme was glucose oxidase; and when the sensing material was fructose valine (98.0%, Fructose Valine, TRC), the corresponding enzyme was fructose valine oxidase.

### WORKING EXAMPLE 1

### Ionic liquid assistance

Hereinafter, the sensing electrodes including various ionic liquids of the Examples and Comparative Examples were used as the working electrode, to investigate the difference between the absence and presence of the ionic liquid layer in the electrical characteristics of the sensing electrodes. In 0.1M PBS purged with nitrogen gas for 30 minutes, glucose (0˜10 mM) or fructose valine (0˜2 mM) of various concentrations were measured by cyclic voltammetry (CV) at mV using the sensing electrode of the enzyme-based glucose or fructose valine sensors fixed by various ionic liquids.

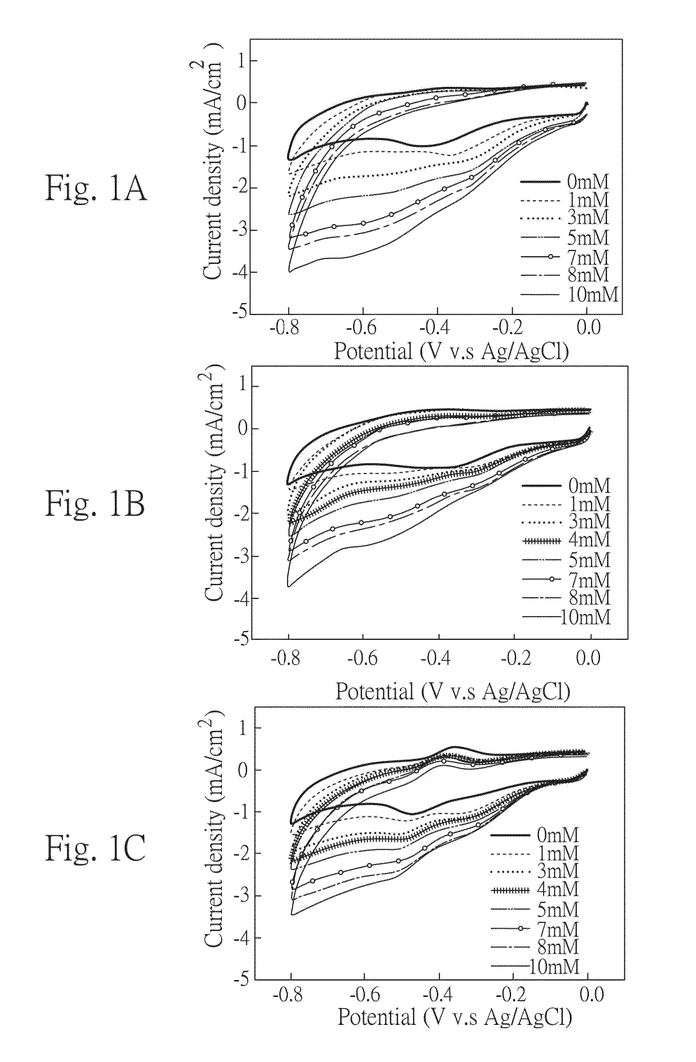

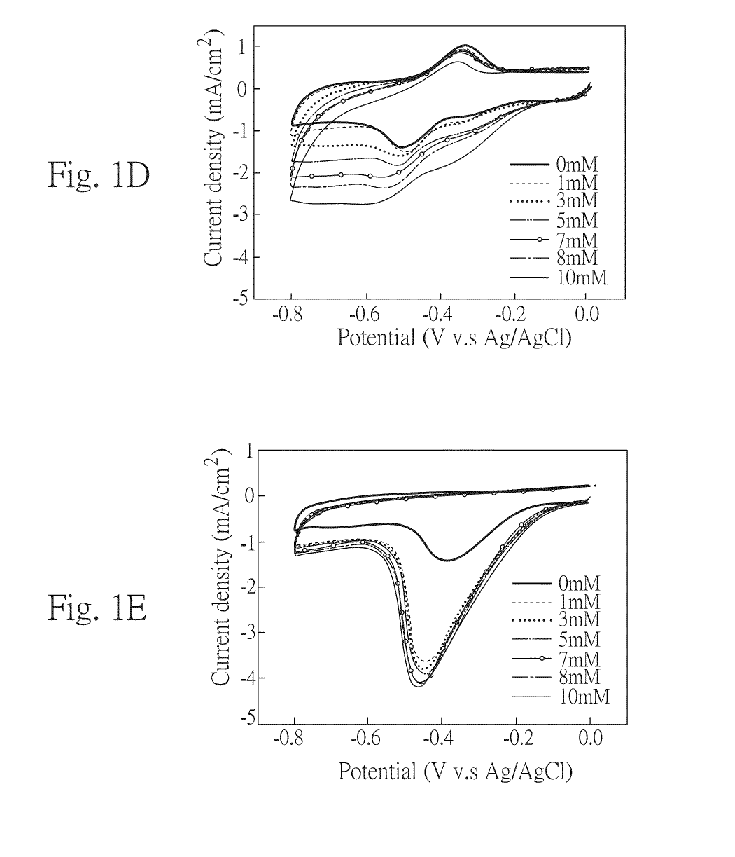

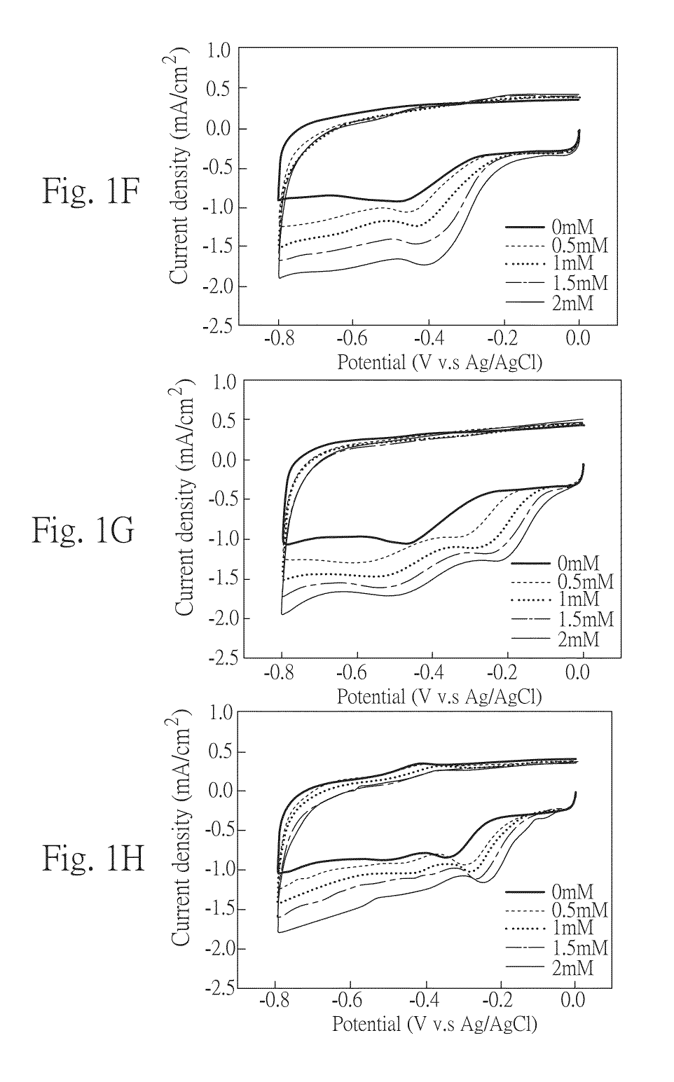

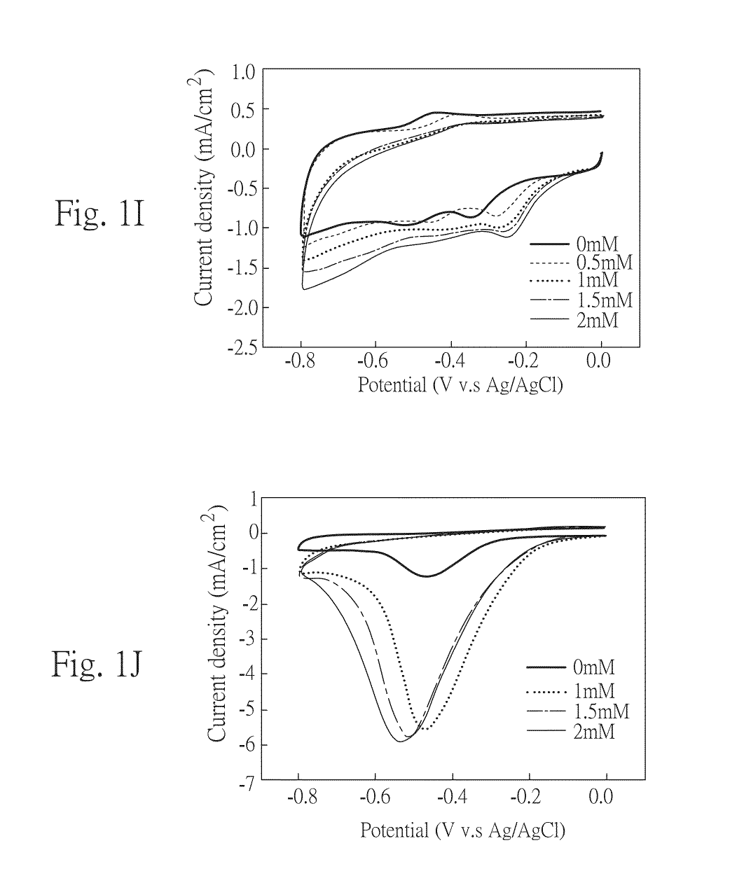

FIGS. 1A to 1E represent the glucose concentrations standardized by detecting the current of hydrogen peroxide, wherein after glucose was added into the reactor, hydrogen peroxide and glucose lactone were generated from the reaction between glucose and oxygen in the solution and the glucose oxidase on the sensing electrodes of Example 1-1, Example 1-2, Example 1-3, Example 1-4, and Comparative Examples 1-1, respectively. FIGS. 1F to 1J represent the glucose concentrations standardized by detecting the current of hydrogen peroxide, wherein after fructose valine was added into the reactor, valine, glucose ketoaldehydes, and hydrogen peroxide were generated from the reaction between oxygen in the solution and the fructose valine oxidase fixed on the sensing electrodes of Example 2-1, Example 2-2, Example 2-3, Example 2-4, and Comparative Examples 2-1, respectively.

There are many conventional methods for detecting hydrogen peroxide. In this Example, the method for detecting reduced hydrogen peroxide was used, and the reaction mechanism is as follows:

H₂O₂+2e⁻+2H⁺→2H₂O

A cyclic voltammetry method was used, wherein the scanning direction was from −0.8V to 0V. First, a cathodic reduction current was generated by the potential of oxygen reduction, and then obvious peaks were generated by glucose oxidase (FIGS. 1A to 1E) and fructose valine oxidase (FIGS. 1F to 1J). The conventional reduction of hydrogen peroxide was difficult to generate an intact peak, and therefore the potential of the accessed current was set at −0.7V to avoid the interference of oxygen and effect of enzyme reduction peak. The oxidation peak obtained in the reverse scanning from −0.8V back to 0V was the oxidation peak of enzymes.

As shown in FIGS. 1A to 1E, the cyclic voltammetry graphs of the sensing electrodes including an ionic liquid layer (FIGS. 1A to 1D, respectively represent Example 1-1, Example 1-2, Example 1-3 and Example 1-4) had a greater symmetry than the sensing electrodes which did not include an ionic liquid layer (FIG. 1E, represents Comparative Example 1-1). It means that the electro-activated substance had a better reversibility on the surface of the electrode. In FIGS. 1F to 1J, the same trend can also be observed. That is, the cyclic voltammetry graphs of the sensing electrodes including an ionic liquid layer (FIGS. 1F to 1I, respectively represent Example 2-1, Example 2-2, Example 2-3 and Example 2-4) had a greater symmetry than the sensing electrodes which did not include an ionic liquid layer (FIG. 1J, represents Comparative Example 2-1), and the electro-activated substance had a better reversibility on the surface of the electrode.

In addition, Examples 1-1 to 1-4 shown in FIGS. 1A to 1D and Examples 2-1 to 2-4 shown in FIGS. 1F to 1I 2-4 were compared with Comparative Example 1-1 shown in FIG. 1E and Comparative Example 2-1 shown in FIG. 1J. Apparently, in Examples 1-1 to 1-4 and Examples 2-1 to 2-4, the current was larger in detection of hydrogen peroxide (H₂O₂), and the interference of oxygen can be suppressed (potential was about −0.45 V).

Next, sensitivity and detection limits of the sensing electrodes of the enzyme-based glucose sensors or the enzyme-based fructose valine sensors fixed by various ionic liquids will be discussed.

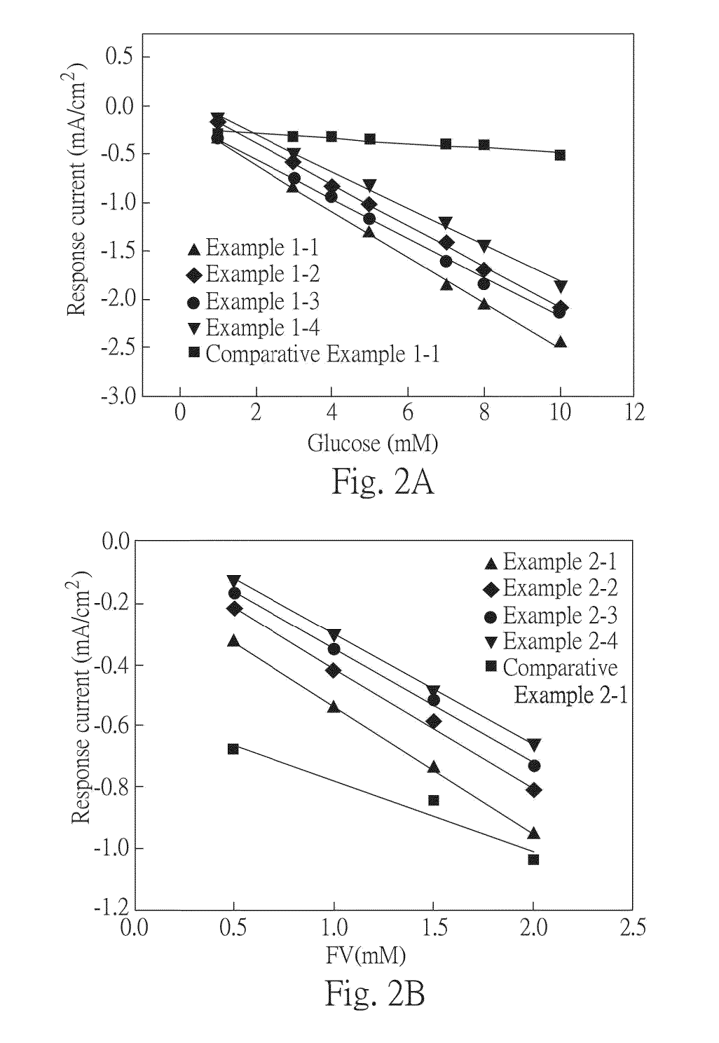

FIG. 2A shows the linear calibration graph of the glucose concentration versus the responding current of the sensing electrode of the enzyme-based glucose sensor fixed by various ionic liquids. In this case, the responding current value was the current value of the potential of −0.7V minus background current value without addition of an analyte. The electrode sensitivity and detection limits of those sensing electrodes were listed in Table 2.

TABLE 2

| enzyme-based | electrode sensitivity | detection limit |
|---|---|---|
| glucose sensor | (μA M⁻¹cm⁻²) | (μM) |
| Example 1-1 | 238.36 | 1.6 |
| Example 1-2 | 212.87 | 2.0 |
| Example 1-3 | 203.65 | 2.1 |
| Example 1-4 | 190.23 | 2.3 |
| Comparative | 22 | 20 |
| Example 1-1 | | |

It can be clearly seen from Table 2 that: the electrode sensitivity and detection limits of the sensing electrodes including an ionic liquid layer (Example 1-1, Example 1-2, Example 1-3 and Example 1-4) were significantly superior to the sensing electrode without an ionic liquid layer (Comparative Example 1-1). Further, the electrode sensitivity and detection limits of the sensing electrodes with the hydrophobic and hydrophilic ionic liquids were compared, and it can be found that Example 1-1 and Example 1-2 using the hydrophobic ionic liquid were superior to Example 1-3 and Example 1-4 using the hydrophilic ionic liquid.

FIG. 2B shows the linear calibration graph of the fructose valine concentration versus the responding current of the sensing electrode of the enzyme-based fructose valine sensor fixed by various ionic liquids. It can be clearly found that the enzyme-based fructose valine sensor had a similar result as the enzyme-based glucose sensor. That is, the electrode sensitivity and detection limits of the sensing electrodes including an ionic liquid layer (Example 2-1, Example 2-2, Example 2-3 and Example 2-4) were significantly superior to the sensing electrode without an ionic liquid layer. Further, the electrode sensitivity and detection limits of the sensing electrodes with the hydrophobic and hydrophilic ionic liquids were compared, and it can be found that Example 2-1 and Example 2-2 using the hydrophobic ionic liquid were superior to Example 2-3 and Example 2-4 using the hydrophilic ionic liquid. The results are summerized in Table 3 below.

TABLE 3

| enzyme-based fructose | electrode sensitivity | detection limit |
|---|---|---|
| valine sensor | (μA M⁻¹cm⁻²) | (μM) |
| Example 2-1 | 415.41 | 6.4 |
| Example 2-2 | 388.58 | 7.2 |
| Example 2-3 | 369.83 | 11.7 |
| Example 2-4 | 358.24 | 8.1 |
| Comparative | 228.41 | 18.9 |
| Example 2-1 | | |

### WORKING EXAMPLE 2

### Storage Time

As described above, the most praised feature of the enzyme sensor is its specificity to the analyte, but it has a stringent requirement for the storage environmental, and an enzyme electrode may loss its enzyme activity at room temperature environment. Therefore, in the following experiments, the sensing electrodes of Examples 1-1 to 1-4 and Comparative Example 1-1 were placed in a stringent environment (i.e., at a room temperature of 25° C.), and the storage time and response current maintenance percentage of glucose were detected, to investigate the effect of the ionic liquid on the storage time of enzymes at room temperature.

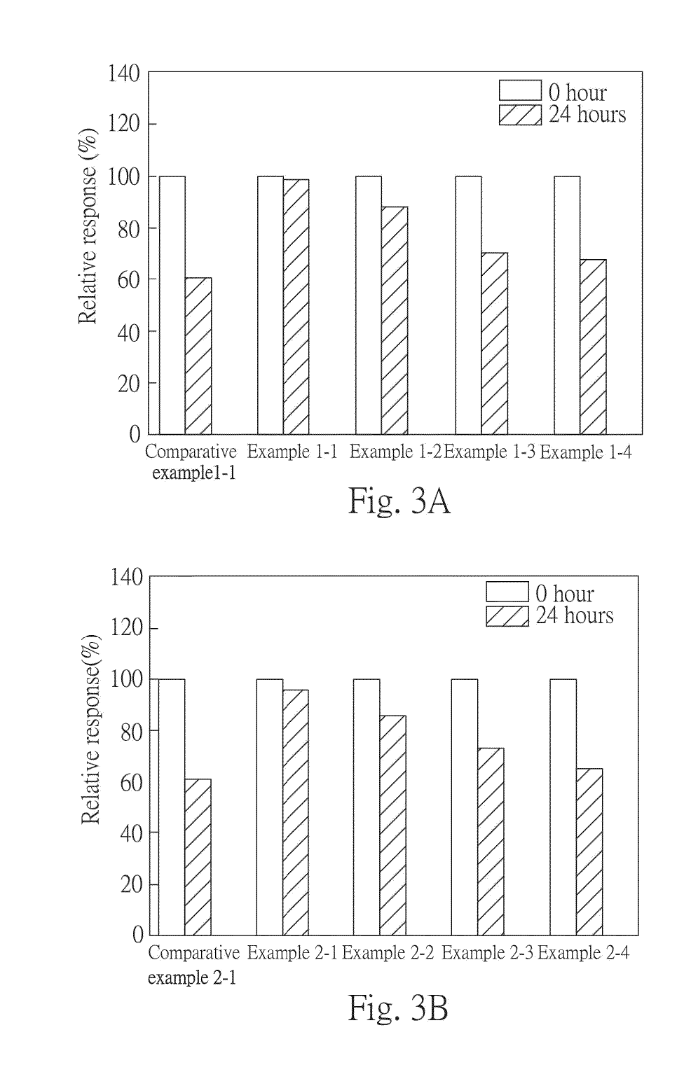

As shown in FIG. 3A, the sensing electrodes of Example 1-1, Example 1-2, Example 1-3, Example 1-4, and Comparative Example 1-1 were subjected to a serving life test. They were placed in ambient environment at room temperature of 25° C., and the time points for the test were: the electrode as prepared (0 hours), and one day (24 hours). In FIG. 3A, the electrode including the most hydrophobic ionic liquid layer of BMPTFSI (Example 1-1) maintained over 95% of the sensing current after 24 hours, while that including EMITFSI (Example 1-2) maintained approximately 90% of the sensing current. The sensing current of BMPDCA (Example 1-3) and EMIDCA (Example 1-4) after 24 hours was also higher than the sensing electrode without an ionic liquid layer (Comparative Example 1-1), indicating that the sensing electrode including an ionic liquid layer, especially those including a hydrophobic ionic liquid layer (Example 1-1, Example 1-2) can maintain a higher enzyme activity of enzymes.

Similar results can also be observed in the enzyme-based fructose valine sensor. As shown in FIG. 3B, after 24 hours, the values of the sensing current in descending order are: Example 2-1>Example 2-2>Example 2-3>Example 2-4>Comparative Example 2-1.

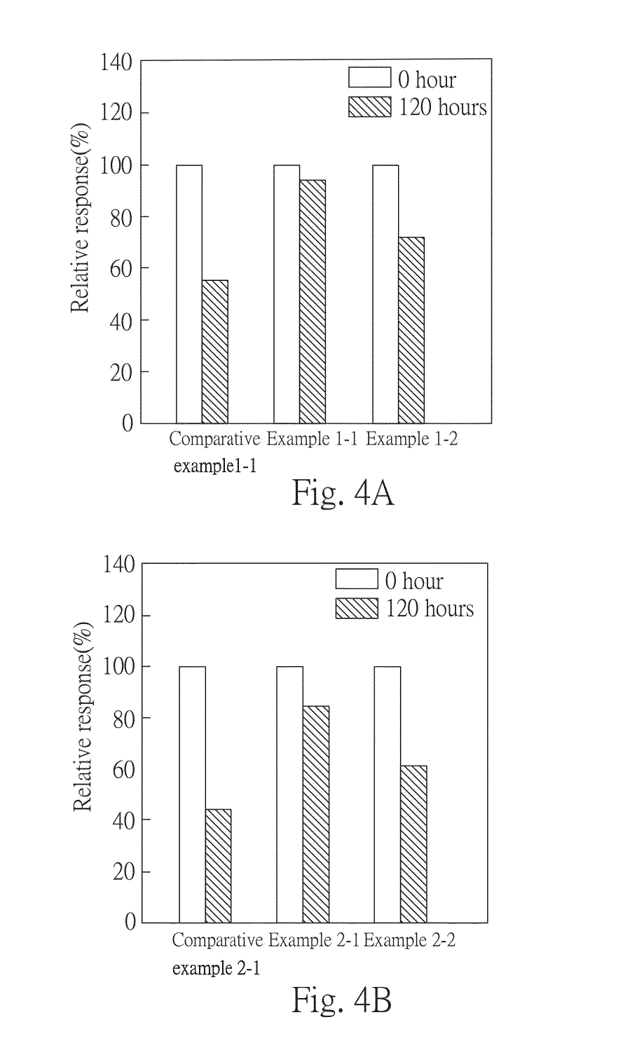

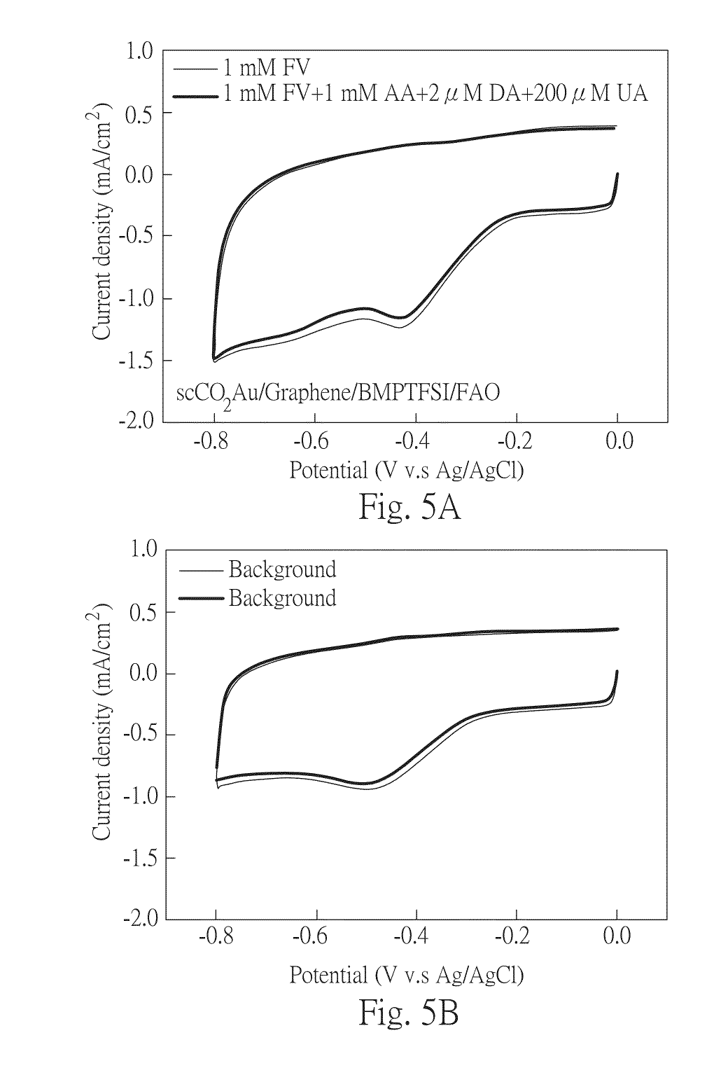

In view of the outstanding performance of the hydrophobic ionic liquid on enzyme activity maintenance, in the following experiments, the sensing electrodes were further placed in ambient environment at room temperature of 25° C. The serving life of the as-prepared sensing electrodes was measured (0 hours), and also, the serving life of the sensing electrodes after 120 hours were measured. It can be clearly found from FIG. 4A that the electrode including the most hydrophobic ionic liquid layer of BMPTFSI (Example 1-1) maintained over 90% of the sensing current after 120 hours, while that including EMITFSI (Example 1-2) maintained approximately 70% of the sensing current. Similarly, in FIG. 4B, the electrode including the most hydrophobic ionic liquid layer of BMPTFSI (Example 2-1) maintained over 85% of the sensing current after 120 hours, while that including EMITFSI (Example 2-2) maintained approximately 60% of the sensing current, all of which were higher than the sensing electrodes without an ionic liquid layer (Comparative Examples 1-1, Comparative Examples 2-1). Obviously, the presence of an ionic liquid layer had a significant impact on the enzyme-based sensor. An ionic liquid layer can maintain a high enzyme activity to provide the sensing electrode with excellent characteristics. In particular, the sensing electrode including a hydrophobic ionic liquid layer can maintain the enzyme activity more effectively in ambient environment at 25° C.

### WORKING EXAMPLE 3

### Disruptors Effect

In this section, the effect of the disruptors on the enzyme-based fructose valine sensor was tested by cyclic voltammetry. More specifically, the sensing electrode of Example 2-1 was used, 1 mM ascorbic acid (AA), similar to the concentration in human blood, 2 μM dopamine (DA), and 200 μM uric acid (UA) were added as the disruptors, 0.1M PBS buffer solution was used as electrolyte, and the scanning rate was 50 mV/s.

As shown in FIG. 4, the sensing electrode of Example 2-1 can maintain 97% of the response current, even in the presence of the disruptors of ascorbic acid (AA), dopamine (DA), and uric acid (UA). Accordingly, the enzyme-based fructose valine sensor according to present invention may exclude the impact of the disruptors and stably detect the long-term glycosylated hemoglobin indicators.

Although the present invention has been explained in relation to its preferred embodiment, it is to be understood that many other possible modifications and variations can be made without departing from the spirit and scope of the invention as hereinafter claimed.

What is claimed is:

1. A sensing electrode of an enzyme-based sensor, comprising:
an electrode substrate; and
an enzyme sensing layer formed on the electrode substrate, wherein the enzyme sensing layer comprises sequentially laminated layers of:
a first carbon material-nano metal layer containing a carbon material and nano-metal particles;
an ionic liquid layer comprising an ionic liquid consisting of a cation and an anion;
a second carbon material-nano metal layer containing a carbon material and nano-metal particles; and
an enzyme layer.

2. The sensing electrode of an enzyme-based sensor of claim 1, wherein the carbon material is selected from the group consisting of: graphene, carbon black, a multi-wall carbon nanotube, a single-wall carbon nanotube, activated carbon, and a carbon sphere.

3. The sensing electrode of an enzyme-based sensor of claim 1, wherein the nano metal particles are selected from the group consisting of: gold nanoparticles, silver nanoparticles, platinum nanoparticles and palladium nanoparticles.

4. The sensing electrode of an enzyme-based sensor of claim 1, wherein the cation of the ionic liquid is: N-alkyl-N-alkyl-pyrrolidinium, 1-alkyl-3-alkyl imidazolium, N-alkyl-N-alkyl-piperidinium, tetraalkylammonium, tetraalkylphosphonium, 1,2-dialkylpyrazolium, N-alkylthiazolium, or trialkylsufonium.

5. The sensing electrode of an enzyme-based sensor of claim 1, wherein the anion of the ionic liquid is: bis(trifluoromethyl)sulfonyl imide (TFSI), dicyanamide (DCA), trifluoromethanesulfonate, tetrafluoroborate, or hexafluorophosphate.

6. The sensing electrode of an enzyme-based sensor of claim 1, wherein the glucose oxidase (GOD) or a fructosyl-amino acid oxidase (FAO).

7. A method for manufacturing the sensing electrode of an enzyme-based sensor, comprising:
(A) coating a slurry comprising a carbon material and nano-metal particles on an electrode substrate to form a first carbon material-nano metal layer;
(B) coating an ionic liquid consisting of a cation and an anion on the first carbon material-nano metal layer to form an ionic liquid layer;
(C) coating the slurry of the step (A) on the ionic liquid layer to form a second carbon material-nano metal layer, so that the ionic liquid layer is sandwiched between the first carbon material-nano metal layer and the second carbon material-nano metal layer; and
(D) forming an enzyme layer on the second carbon material-nano metal layer.

8. The method of claim 7, wherein the nano-carbon material and the nano-metal particles in the step (A) forms a carbon material-nano metal composite in a supercritical carbon dioxide environment.

9. The method of claim 7, wherein the carbon material in the step (A) is selected from the group consisting of: graphene, carbon black, a multi-wall carbon nanotube, a single-wall carbon nanotube, activated carbon, and a carbon sphere.

10. The method of claim 7, wherein the nano metal particles are selected from the group consisting of: gold nanoparticles, silver nanoparticles, platinum nanoparticles and palladium nanoparticles.

11. The method of claim 7, wherein the cation of the ionic liquid is: N-alkyl-N-alkyl-pyrrolidinium, 1-alkyl-3-alkyl imidazolium, N-alkyl-N-alkyl-piperidinium, tetraalkylammonium, tetraalkylphosphonium, 1,2-dialkylpyrazolium, N-alkylthiazolium, or trialkylsufonium.

12. The method of claim 7, wherein the anion of the ionic liquid is: bis(trifluoromethyl)sulfonyl imide (TFSI), dicyanamide (DCA), trifluoromethanesulfonate, tetrafluoroborate, or hexafluorophosphate.

13. The method of claim 7, wherein the enzyme layer comprises a glucose oxidase (GOD) or a fructosyl-amino acid oxidase (FAO).
